(19) United States
(12) Patent Application Publication
(10) Pub. No.: US 2007/0046015 A1
(43) Pub. Date: Mar. 1, 2007

(54) Seat belt apparatus and vehicle

(75) Inventors: Koji Tanaka, Tokyo (JP); Koji Inuzuka, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/509,702

(22) Filed: Aug. 25, 2006

(30) Foreign Application Priority Data
Aug. 29, 2005 (JP) 2005-247643

(51) Int. Cl. B60R 22/46; B60R 22/00; B60R 21/00

(52) U.S. Cl. 280/806; 297/480; 180/268

(57) ABSTRACT

The disclosed seat belt apparatus can comprises a seat belt, a first winding-up mechanism for winding up the seat belt from the first end side of the seat belt, a second winding-up mechanism for winding up the seat belt from the second end side of the seat belt. The first and second winding-up mechanism are configured to operate such that after a buckle release, a first portion of the seat belt is first wound up and a second portion of the seat belt is then wound up.

### BACKGROUND

The present application discloses a seat belt apparatus to be installed in a vehicle.

Conventionally, seat belt apparatuses of various structures for restraining a vehicle occupant in a vehicle, such as an automobile, are known. For example, Japanese Unexamined Patent Publication No. 2005-170123 (incorporated by reference herein) discloses a seat belt apparatus having a seat belt retractor in which a spool (or winding shaft) is rotated by an electric motor so as to wind up a seat belt.

In the seat belt apparatus of this kind, a seat belt storing action of winding up a seat belt (or webbing) is taken for the purpose of preventing the seat belt from being kept in the unwound state from the spool after the cancellation of the latching of a tongue to a buckle, i.e. the buckle release. A structure for winding up the seat belt using an electric motor as described in the Japanese Publication 2005-170123 or using a return spring may be employed for performing this seat belt storing action. For optimizing the seat belt storing action, it is desired to pursue the speed-up of the seat belt winding, the reduction in load for the seat belt winding, and the facilitation of the seat belt winding while taking the motion of the seat belt including the tongue into consideration.

### SUMMARY

Therefore, the application discloses a technology effective for optimizing the seat belt storing action in a seat belt apparatus to be installed in a vehicle.

The disclosed technology is typically adapted to a seat belt apparatus to be installed in an automobile. In addition, the technology can be adapted to a seat belt apparatus to be installed in a vehicle other than the automobile, such as an aircraft, a boat, a train, and a bus.

The seat belt apparatus according to a first disclosed embodiment is a device to be installed in a vehicle and can comprise at least a seat belt, a first winding-up means, a second winding-up means, a deflection fitting, a tongue, and a buckle.

The seat belt of the present application may be a long belt to be worn by a vehicle occupant seated in a vehicle seat and is sometimes called a webbing. Typically, the vehicle occupant seated in the vehicle seat is restrained by the seat belt when restraint is required, such as during a vehicle collision.

The first winding-up means of the present embodiment can be structured as a means for winding up the seat belt from one end side thereof. Conversely, the second winding-up means can be structured as a means which is disposed in a region around the occupant's door-side hip to wind up the seat belt from the other end side thereof. The “region around the occupant's door-side hip” can include a region in a vehicle corresponding to the door-side hip of the vehicle occupant and the periphery thereof. The first winding-up means and the second winding-up means can each comprise a spool for winding up the seat belt and a power source for rotating the spool in the winding direction. For the power source, one or more of a group consisting of a return spring, an electric motor, and a pyrotechnic drive unit may be employed.

The deflection fitting of this embodiment has a function of holding the seat belt to a region around the occupant's shoulder. The “region around the occupant's shoulder” may include a region in a vehicle corresponding to the shoulder of the vehicle occupant and the periphery thereof. The tongue of this embodiment is attached to the seat belt and is latched to the buckle, which is disposed in the region around the occupant's cabin-side hip, when the seat belt is worn. The “region around the occupant's cabin-side hip” may include a region in a vehicle corresponding to the cabin-side hip of a vehicle occupant and the periphery thereof.

The seat belt can extend from the first winding-up means through the deflection fitting and can further extend to the second winding-up means through the tongue. The seat belt can form a shoulder belt portion on the first winding-up means side before the tongue and a lap belt portion on the second winding-up means side after the tongue when the tongue is latched to the buckle so that the seat belt is worn. The shoulder belt portion can be structured as a part of the seat belt extending across the chest and the shoulder of the vehicle occupant. The lap belt portion may be structured as another part of the seat belt extending across the abdomen and the hip of the vehicle occupant.

The first winding-up means and the second winding-up means are adapted to operate such that after canceling the latching of the tongue relative to the buckle, i.e. the buckle release, the lap belt portion of the seat belt is first wound up and the shoulder belt portion of the seat belt is then wound up.

According to the arrangement of the seat belt apparatus according to the first disclosed embodiment, the improvement of the seat belt storing action can be achieved.

By first winding up the lap belt portion just after the buckle release, the tongue held in the region around the occupant's cabin-side hip via the buckle moves substantially horizontally toward the region around occupant's door-side hip according to the winding-up of the lap belt portion so that the tongue moves to a position so as not to disturb the vehicle occupant when getting out of the vehicle. The moving path of the tongue is a path across the abdomen or the hip of the vehicle occupant which is shorter than the path of the tongue in the case of moving to an upper part of the vehicle, thereby shortening the time it takes for the tongue to move to a position that does not disturb the vehicle occupant when getting out of the vehicle. The moving path lies below normal eye level of the vehicle occupant and far away from the range of view of the vehicle occupant, thereby preventing the vehicle occupant from feeling uncomfortable due to the movement of the tongue. Because the tongue moves substantially horizontally during the wind up of the lap belt portion, the driving force of the second winding-up means can be reduced as compared to the case of winding-up so as to lift the tongue, thus enabling a reduction in size, weight, and cost of the second winding-up means. By the arrangement of mainly storing the lap belt portion, the lap belt portion including the tongue is prevented from disturbing the vehicle occupant when getting out of the vehicle and is also prevented from being caught by the door. Therefore, it is no longer necessary to rapidly wind up the shoulder belt portion after winding up the lap belt portion. The winding speed by the first winding-up means can be reduced, thereby preventing discordant operating sound and noise generation due to the first winding-up means.

The second disclosed embodiment is a seat belt apparatus in which the first winding-up means can comprise a first return spring and an electric motor for applying the winding-up force to a first spool for winding up the seat belt. The second winding-up means can comprise a second return spring for applying the winding-up force to a second spool for winding up the seat belt. The winding-up force applied to the seat belt by the second return spring is set to be larger than the winding-up force of the first return spring and to be smaller than the total winding-up force of the first return spring and of the electric motor when driven.

The lap belt portion can be wound up onto the second spool of the second winding-up means by controlling the electric motor of the first winding-up means to not be driven. That is, in the state when the electric motor is not driven, the winding-up force applied to the seat belt by the second return spring overcomes the winding-up force of the first return spring so that the lap belt portion is wound up onto the second spool.

On the other hand, the shoulder belt portion is wound up onto the first spool of said first winding-up means by controlling the electric motor of the first winding-up means to be driven. That is, in the state when the electric motor is driven, the total winding-up force of the first return spring and of the electric motor when driven overcomes the winding-up force of the second return spring so that the shoulder belt portion is wound up onto the first spool.

According to the aforementioned arrangement of the seat belt apparatus, because the seat belt winding-up force of the first return spring involving the winding-up of the shoulder belt portion is set to be smaller than the seat belt winding-up force of the second return spring involving the winding-up of the lap belt portion, the workload of pulling the seat belt from the first spool is light, thus facilitating the operation for wearing the seat belt. In addition, the uncomfortable feeling of the vehicle occupant due to the load applied via the shoulder belt portion when the vehicle occupant wears the seat belt can be reduced.

The third disclosed embodiment is a seat belt apparatus in which the first winding-up means can comprise a first return spring for applying the winding-up force to a first spool for winding up the seat belt. On the other hand, the second winding-up means can comprise a second return spring and an electric motor for applying the winding-up force to a second spool for winding up the seat belt. In addition, the winding-up force applied to the seat belt of the first return spring is set to be larger than the winding-up force of the second return spring and to be smaller than the total winding-up force of the second return spring and of the electric motor when driven.

With the arrangement as mentioned above, the lap belt portion can be wound up onto the second spool of the second winding-up means by controlling the electric motor of the second winding-up means to be driven. That is, when the electric motor is driven, the total winding-up force of the second return spring and of the electric motor overcomes the winding-up force of the first spring force so that the lap belt portion is wound onto the second spool.

On the other hand, the shoulder belt portion may be wound up onto the first spool of the first winding-up means by controlling the electric motor of the second winding-up means to not be driven. That is, when the electric motor is not driven, the winding-up force applied onto the seat belt via the first return spring overcomes the winding-up force of the second return spring so that the shoulder belt portion is wound onto the first spool.

According to the aforementioned arrangement of the seat belt apparatus of the third embodiment, because the electric motor is used as a power source for the second spool of the second winding-up means and the electric motor is driven only within a relatively short period of time just after the buckle release, there is a reduction in the time of discordant motor operating sound and noise generation due to the electric motor.

The fourth disclosed embodiment is a seat belt apparatus in which the first winding-up means can comprise an electric motor for applying the winding-up force to a first spool for winding up the seat belt. On the other hand, the second winding-up means can comprise a return spring for applying the winding-up force to a second spool for winding up the seat belt. In addition, the winding-up force applied to the seat belt by the return spring is set to be larger than the winding-up force by the electric motor when not driven and to be smaller than the winding-up force by the electric motor when driven.

With the arrangement as mentioned above, the lap belt portion is wound up onto the second spool of the second winding-up means by controlling the electric motor of the first winding-up means to not be driven. That is, when the electric motor is not driven, the lap belt portion is wound onto the second spool with the winding-up force applied to the seat belt by the return spring of the second winding-up means.

On the other hand, the shoulder belt portion is wound up onto the first spool of the first winding-up means by controlling the electric motor of the first winding-up means to be driven. That is, when the electric motor is driven, the winding-up force of the electric motor overcomes the winding-up force of the return spring of the second winding-up means so that the shoulder belt portion is wound onto the first spool.

According to the aforementioned arrangement of the seat belt apparatus, no return spring is required in the first winding-up means, thereby achieving the simplification, the miniaturization, the reduction in weight, and the reduction in cost of the first winding-up means.

The fifth disclosed emobodiment is a vehicle comprising at least a running system including an engine, an electrical system, a drive control device, and a seat belt apparatus. The running system including an engine can be a system related to the driving of the vehicle by the engine. The electrical system can be a system related to the electrical parts used in the vehicle. The drive control device can be a device having a function of conducting the drive control of the running system and the electrical system. The seat belt apparatus is structured as an apparatus for restraining a vehicle occupant in the event of a vehicle collision. In the present embodiment, the seat belt apparatus can be a seat belt apparatus according to any disclosed embodiment.

According to the arrangement as mentioned above, a vehicle with a seat belt apparatus can be provided in which the optimization of the seat belt storing action is achieved.

As described above, the present application relates to a seat belt apparatus to be installed in a vehicle and enables the optimization of the seat belt storing action by adapting the seat belt apparatus to operate such that after the cancellation of the latching of a tongue relative to a buckle, i.e. the buckle release, a lap belt portion as a part of a seat belt is first wound up and a shoulder belt portion as another part of the seat belt is then wound up.

It is to be understood that both the foregoing general description and the following detailed descriptions are exemplary and explanatory only, and are not restrictive of the invention as claimed.

### BRIEF DESCRIPTION OF THE DRAWINGS

The features, aspects and advantages of the present invention will become apparent from the following description, appended claims, and the accompanying exemplary embodiments shown in the drawings, which are briefly described below.

FIG. 1 is a schematic drawing showing a seat belt apparatus according to an disclosed embodiment.

FIG. 2 is a schematic drawing showing a first retractor and a second retractor in the seat belt apparatus shown in FIG. 1.

FIG. 3 is a flow chart for the belt winding and storing control method in the seat belt apparatus according to an disclosed embodiment.

FIG. 4 is a graph showing the changes in seat belt winding-up force with time in the belt winding and storing control method of the seat belt apparatus according to an disclosed embodiment.

FIG. 5 is a schematic drawing showing the seat belt apparatus in a first control mode state for a seat belt according to an disclosed embodiment.

FIG. 6 is a schematic drawing showing the seat belt apparatus in a second control mode state for the seat belt according to an disclosed embodiment.

FIG. 7 is a schematic drawing showing the seat belt apparatus in a state in which the belt winding and storing control method for the seat belt is terminated according to an disclosed embodiment.

FIG. 8 is a schematic drawing showing a first retractor and a second retractor in the seat belt apparatus according to another disclosed embodiment.

FIG. 9 is a flow chart for the belt winding and storing control method in the seat belt apparatus according to another disclosed embodiment.

FIG. 10 is a graph showing the changes in seat belt winding-up force with time in the belt winding and storing control method in the seat belt apparatus according to another disclosed embodiment.

FIG. 11 is a schematic drawing of a first retractor and a second retractor in the seat belt apparatus according to yet another disclosed embodiment.

FIG. 12 is a schematic drawing of a first retractor and a second retractor in the seat belt apparatus according to yet another disclosed embodiment.

### DETAILED DESCRIPTION

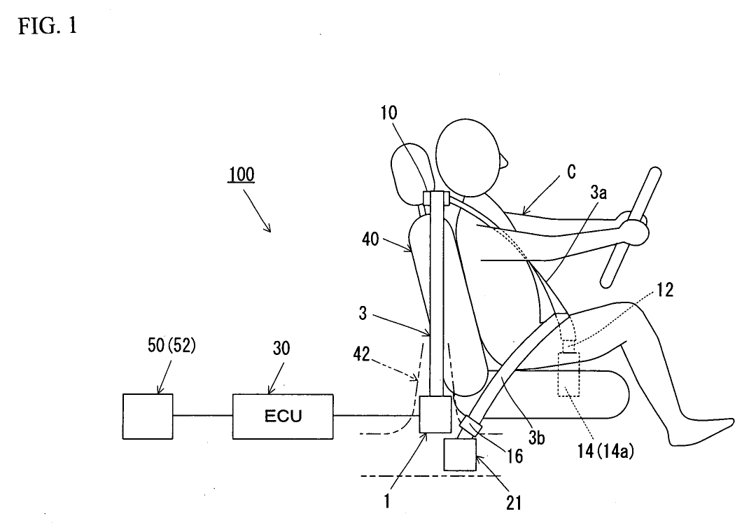

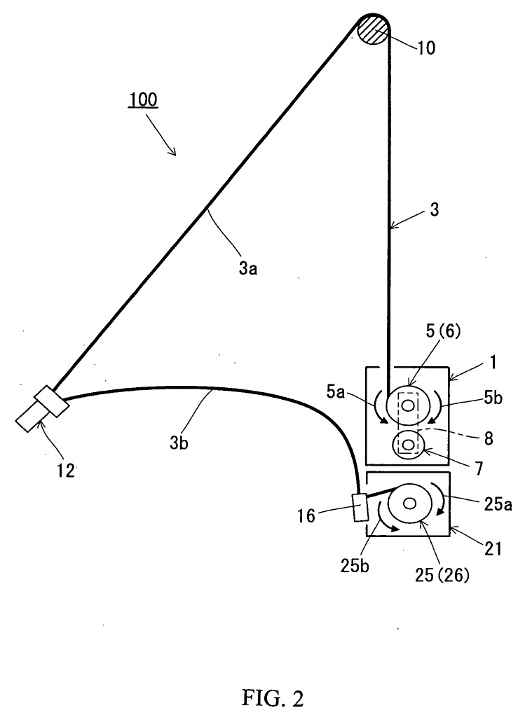

Hereinafter, the disclosed embodiments will be described in detail with reference to drawings. First, reference will be made to FIGS. 1 and 2 in regard to a seat belt apparatus according to an disclosed embodiment.

FIG. 1 is an illustration showing the entire structure of a seat belt apparatus 100. FIG. 2 is an illustration showing the schematic structure of a first retractor 1 and a second retractor 21 in the seat belt apparatus 100 shown in FIG. 1.

As shown in FIG. 1, the seat belt apparatus 100 of this embodiment is a seat belt apparatus for a vehicle to be installed in an automotive vehicle and may mainly comprise a first retractor 1, a seat belt 3, a deflection fitting 10, a tongue 12, a buckle 14, a webbing guide 16, a second retractor 21 and an ECU 30. The first retractor 1 and the second retractor 21 are disposed in an accommodation space within a B pillar 42 of the vehicle at a region around the occupant's door-side hip. The “region around the occupant's door-side hip” includes a region in a vehicle corresponding to the door-side hip of a vehicle occupant C and the periphery thereof. The first retractor 1 may be disposed in an accommodation space in the B pillar 42 at a region around the occupant's shoulder or an accommodation space in a vehicle seat, if required.

In addition, an input element 50 is installed in the vehicle to detect and to input various information to the ECU 30. The information to be detected can include information about a collision prediction or a collision occurrence of the vehicle, information about the driving state of the vehicle, information about the sitting position and the body size of the vehicle occupant seated in the seat, information about the traffic conditions around the vehicle, information about the weather conditions and about time zones, and the like. The detected information of the input element 50 is transmitted to the ECU 30 anytime or at predetermined intervals and is used for the operational control of a running system which includes an engine, an electrical system, the seat belt apparatus 100, and/or the like. Therefore, the ECU 30 serves as a vehicle control device for controlling the actuation of a running system including an engine and an electrical system.

The input element 50 can include a collision information detection sensor 52 for detecting information about a vehicle collision, such as a prediction of a vehicle collision and an occurrence of an actual vehicle collision. The collision information detection sensor 52 is a sensor capable of detecting (or measuring) information (or a signal) about the distance, the speed, and the acceleration of a collision object (such as another vehicle, an obstacle, a pedestrian, or the like) relative to the subject vehicle and also detecting (or measuring) accelerations in three-axial (X-axis, Y-axis, and Z-axis) directions acting on the subject vehicle. The collision information detection sensor 52 may comprises a single detection sensor or a combination of single detection sensors. Specifically, millimeter wave radar, laser radar, acceleration sensor, camera sensor and the like may be used as the collision information detection sensor 52.

The seat belt 3 is a long belt (or webbing) to be used for restraining the vehicle occupant C (such as a driver) seated in a vehicle seat 40 (such as a driver's seat). In the state where the seat belt is worn as shown in FIG. 1, the seat belt 3 is withdrawn from the first retractor 1 fixed relative to the vehicle, extends through the deflection fitting 10 provided in a region around the shoulder of the vehicle occupant C, further extends through the tongue 12 and the webbing guide 16, and is connected to the second retractor 21. The seat belt 3 includes different portions. That is, a shoulder belt portion 3a of the seat belt 3 is formed on the first retractor 1 side (the deflection fitting 10 side) before the tongue 12 and extends across the chest and the shoulder of the vehicle occupant 10. Also, a lap belt portion 3b of the seat belt 3 is formed on the second retractor 21 side after the tongue 12 and extends across the abdomen and the hip of the vehicle occupant C.

The deflection fitting 10 has a function of holding the seat belt 3 to the area about the shoulder of the occupant C and guiding the seat belt 3. The “region around the occupant's shoulder” includes a region in a vehicle corresponding to the shoulder of the vehicle occupant and the periphery thereof. By inserting (i.e., latching) the tongue 12 into the buckle 14 fixed to a region around the occupant's cabin-side hip of the vehicle body, the seat belt 3 goes into the state of being worn by the vehicle occupant C. The “region around the occupant's cabin-side hip” may include a region in the vehicle corresponding to the cabin-side hip of the vehicle occupant C and the periphery of the region. The region around the occupant's cabin-side hip is located on the opposite side of the vehicle occupant C from the region around the occupant's door-side hip where the first retractor 1 and the second retractor 21 are disposed. On the other hand, by canceling the latching of the tongue 12 to the buckle 14, the seat belt apparatus goes into the unbuckled state.

The buckle 14 has a built-in buckle switch 14a. The buckle switch 14a detects that the tongue 12 is inserted into the buckle 14 so as to connect the seat belt to the buckle (i.e., detects that the seat belt goes into the worn state). The information detected by the buckle switch 14a is transmitted to the ECU 30 which determines whether or not the seat belt 3 is in the worn state.

The ECU 30 has a function of conducting the control of the first retractor 1 and other operational mechanisms based on the input signals from the input element 50 and can comprise a CPU (central processing unit), an input/output unit, a storage unit, a peripheral unit, and the like. Particularly in this embodiment, the ECU 30 controls the motor 7, as will be described later, of the first retractor 1. Specifically, the ECU 30 can control the amount of current supplied to an electromagnetic coil of the motor 7 and the direction of the current supply so as to vary the rotational speed, the rotational direction, the rotational period of time, and the rotational torque (the output) of a shaft of the motor 7. The ECU 30 may be structured as a means for controlling the driving of the motor 7 and controlling a power transmission mechanism 8, as will be described later, to switch between the state where the power of the motor 7 is transmitted to a first spool 5 and the state where the power is not transmitted to the first spool 5. Further, the ECU 30 can also provide a function of detecting (or measuring) the current value of the motor 7 in operation.

The ECU 30 may be exclusive to the first retractor 1 or used not only for the first retractor 1 but also for other control means for controlling the driving system and/or the electric system of the vehicle.

As shown in FIG. 2, the first retractor 1 can be structured as a means for winding up the seat belt 3 from one end side thereof and can have a retractor housing. The first retractor 1 can comprise at least the first spool 5, a first return spring 6, the motor 7, and the power transmission mechanism 8 within the retractor housing.

The first spool 5 is formed in a columnar or cylindrical shape of which the outer periphery (the seat belt contact face) functions as the wind-up surface on which the seat belt 3 is wound. The first spool 5 is allowed to rotate in the seat belt winding direction 5a and the seat belt unwinding direction 5b. The first return spring 6 is structured as a member for applying a winding-up force to the first spool 5 for winding up the seat belt 3. The motor 7 is structured as an electric motor for applying a winding-up force to the first spool 5 similarly to the first return spring 6. As mentioned above, in the first retractor 1, the first return spring 6 and the motor 7 are power sources for winding up the seat belt 3 onto the first spool 5.

The power transmission mechanism 8 is arranged between the first spool 5 and the motor 7. The power transmission mechanism 8 can be structured as a mechanism capable of creating a connected state where the first spool 5 and the motor 7 are connected (the power transmission operation mode) and a disconnected state where the connected state is cancelled (the power transmission disconnection mode or the power transmission canceling mode). The power transmission mechanism 8 is sometimes referred to as a “clutch” which can comprise a combination of gears. The connected state of the power transmission mechanism 8 is a state where the power of the motor 7 is allowed to be transmitted to the first spool 5 via the power transmission mechanism 8. When the motor 7 is driven in this connected state, the power of the motor 7 is transmitted to the first spool 5 via the power transmission mechanism 8. During this, the rotational speed of the motor 7 is reduced by the power transmission mechanism 8. Conversely, in the disconnected state of the power transmission mechanism 8, the physical connection between the first spool 5 and the motor 7 is cancelled so as to allow the easy unwinding (or withdrawing) of the seat belt 3 from the first spool 5. It should be noted that, in the embodiment, the first spool 5 and the motor 7 may be directly connected without the power transmission mechanism 8 between the first spool 5 and the motor 7, if required.

The power transmission mechanism 8 of the first retractor can be constructed as a “single-stage clutch,” but is not illustrated as such. Accordingly, when the motor 7 is driven with a predetermined motor output in the power transmission operation mode of the power transmission mechanism 8, the rotation of the motor 7 is transmitted to the first spool 5 with the rotational speed being reduced so that the first spool 5 is rotated with a predetermined rotational torque at a predetermined rotational speed.

Instead of the power transmission mechanism 8, a power transmission mechanism capable of changing the rotational torque and the rotational speed of the spool at several stages may be employed. For example, in case of a two-stage clutch capable of changing the rotational torque and the rotational speed of the spool at two stages, the power transmission mechanism can be set in a high-reduction ratio mode with a relatively high rotational torque and a relatively low rotational speed in order to respond to a need for the winding of the seat belt onto the spool with a large belt tension. On the other hand, the power transmission mechanism can be set in a low-reduction ratio mode with a relatively low rotational torque and a relatively high rotational speed in order to respond to a need for a rapid winding of the seat belt onto the spool.

On the other hand, as shown in FIG. 2, the second retractor 21 can be structured as a means for winding up the seat belt 3 from the other end side thereof (the opposite side from the first retractor 1) and can have a retractor housing. The second retractor 21 can comprise at least a second spool 25 and a second return spring 26 within the retractor housing.

The second spool 25 may be formed in a columnar or cylindrical shape of which the outer periphery (the seat belt contact face) functions as the wind-up surface on which the seat belt 3 is wound. The second spool 25 is allowed to rotate in the seat belt winding direction 25a and the seat belt unwinding direction 25b. The second return spring 26 can be structured as a member for applying a winding-up force to the second spool 25 for winding up the seat belt 3. As mentioned above, in the second retractor 21, the second return spring 26 can be a power source for winding up the seat belt 3 onto the second spool 25.

In this embodiment, the winding-up force applied to the seat belt 3 by the second return spring 26 of the second retractor 21 is set to be larger than the winding-up force applied by the first return spring 6 of the first retractor 1 and smaller than the total winding-up force of the first return spring 6 and of the motor 7 when driven.

In this embodiment, the following seven seat belt setting modes of the seat belt 3 are set. Based on these seat belt setting modes, the motor 7 and the power transmission mechanism 8 are controlled by the ECU 30.

(1) Belt Storage Mode

The belt storage mode is a mode in which the seat belt 3 is not used and fully wound onto the first spool 5 and the second spool 25. In the first retractor 1 in the belt storage mode, the motor 7 is not driven and the power transmission mechanism 8 is set to the power transmission disconnection mode. Therefore, only a very weak belt tension is applied to the seat belt 3 and the power consumption is zero.

(2) Belt Withdrawing Mode

The belt withdrawing mode is a mode in which the seat belt 3 is withdrawn from the first spool 5 and the second spool 25 so as to be worn by the occupant. The first retractor 1 in the belt withdrawing mode is also set in the power transmission disconnection mode. Therefore, the seat belt 3 can be withdrawn with a small force. Also in this case, the motor 7 is not driven so that the power consumption is zero.

(3) Belt Winding and Fitting Mode

The belt winding and fitting mode is a mode in which, after the seat belt 3 is withdrawn and the tongue (such as the tongue 12 in FIG. 1) is inserted into and latched with the buckle to turn ON the buckle switch (such as the buckle switch 14a in FIG. 1), an excessively withdrawn part of the seat belt 3 is wound in order to fit the seat belt 3 to the occupant. Alternatively, the belt winding and fitting mode is a mode in which when the occupant moves so as to withdraw a predetermined amount of the seat belt 3 from the normally worn state of the seat belt 3 (at this point, the buckle switch is in the ON state) and when the occupant returns to the original position, the withdrawn part of the seat belt 3 is wound. In the first retractor 1 in the belt winding and fitting mode, the power transmission mechanism 8 is set to the power transmission operation mode and the motor 7 is controlled to be driven to rotate at a high rotational speed in the belt winding direction. Therefore, the seat belt 3 is rapidly wound onto the first spool 5 and then the motor 7 is stopped when a very small predetermined belt tension is generated, whereby the seat belt 3 is worn by and fitted to the occupant.

(4) Normal Wearing Mode (Comfortable Mode)

The normal wearing mode (or the comfortable mode) is a mode in which the occupant wears the seat belt 3 in the normal state after the belt winding and fitting mode is terminated. In the first retractor 1 in the normal wearing mode, the motor 7 is not driven and the power transmission mechanism 8 is set in the power transmission disconnection mode. Therefore, only a very weak belt tension is applied to the seat belt 3 so that the vehicle occupant can wear the seat belt 3 without any stress. In addition, the power consumption is zero.

(5) Warning Mode

The warning mode is a mode in which when the system detects the driver dozing or detects an obstacle around the subject vehicle when the seat belt is in the normal wearing mode during running, the seat belt 3 is wound repeatedly at predetermined times so as to warn the driver. In the first retractor 1 in the warning mode, the motor 7 is controlled to be driven repeatedly. Therefore, the operation of applying a relatively strong belt tension (which is weaker than that of the belt tension during the emergency mode as will be described later) and a very weak belt tension onto the seat belt 3 is alternately repeated, thereby drawing the driver's attention to the driver's dozing and/or the obstacle around the subject vehicle.

(6) Emergency Mode

The emergency mode is a mode which is set when the vehicle is extremely likely to have a collision with an obstacle or the like during the run of the normal wearing mode or following the aforementioned warning mode. In the first retractor 1 in the emergency mode, the power transmission mechanism 8 is set in the power transmission operation mode and the motor 7 is controlled to rotate at a high rotational speed with a high rotational torque in the belt winding direction. Therefore, the motor 7 is stopped when a predetermined extremely strong belt tension is generated on the seat belt 3 after the seat belt 3 is rapidly wound onto the first spool 5, thereby securely restraining the vehicle occupant with the seat belt 3.

(7) Belt Winding and Storing Mode

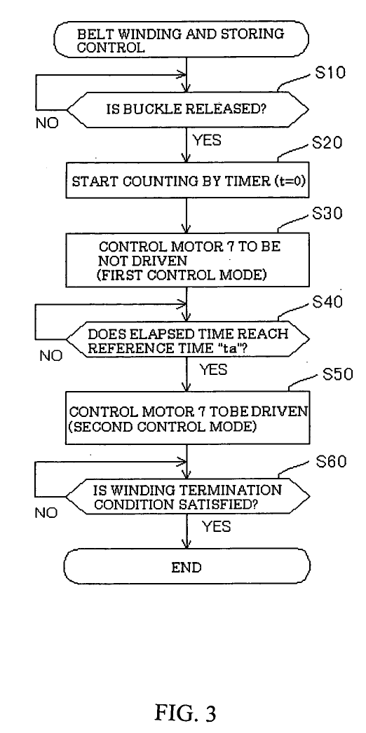

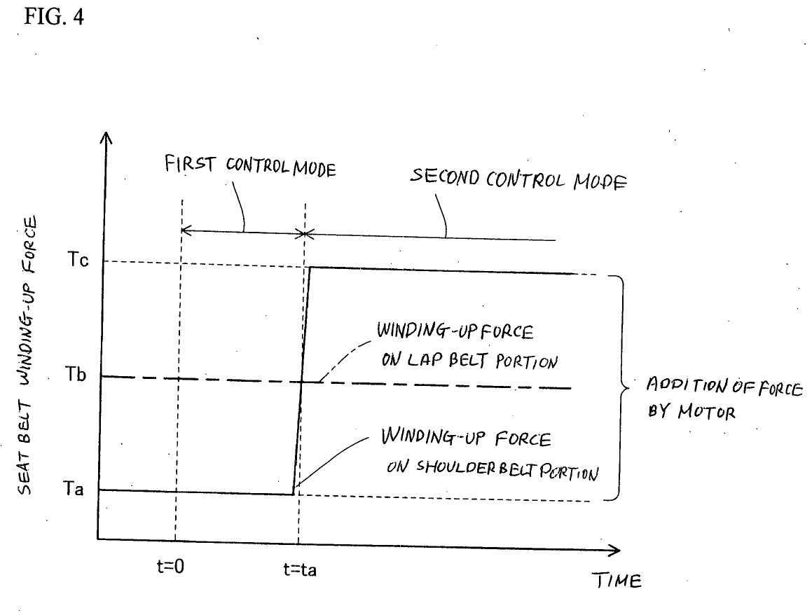

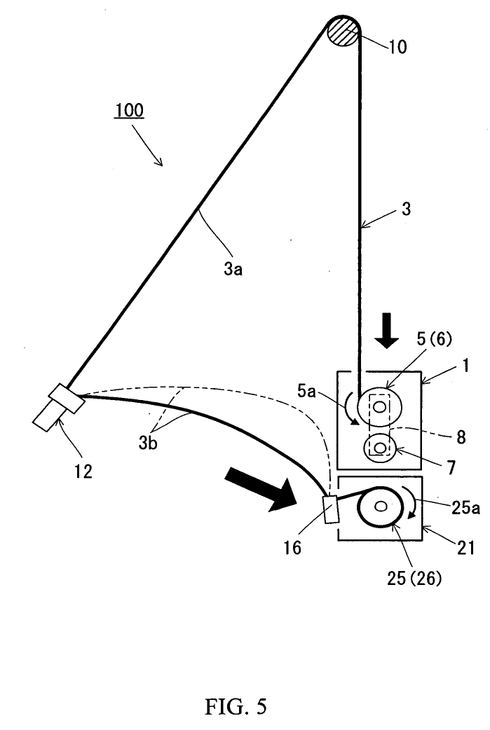

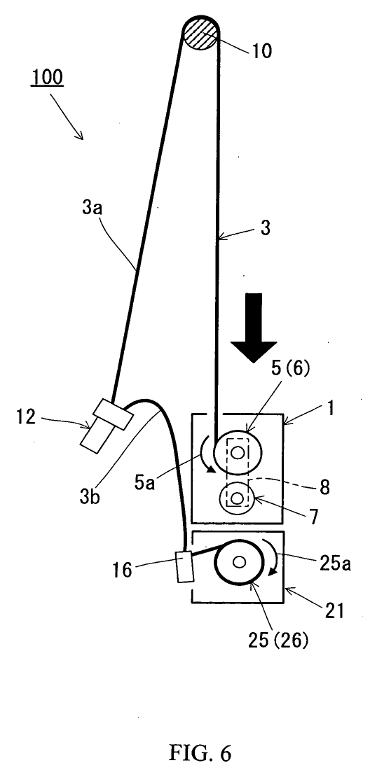

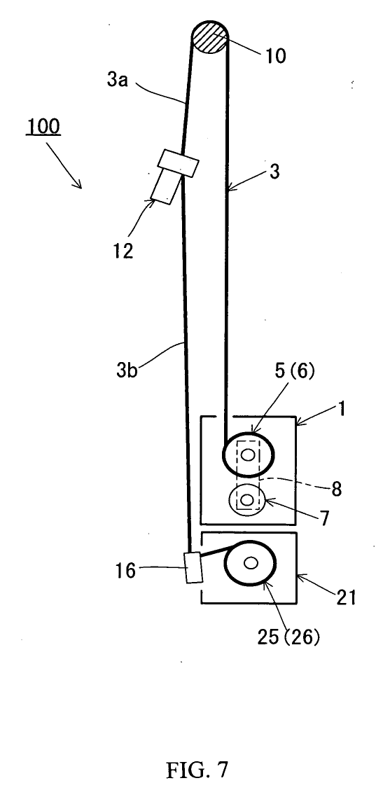

The belt winding and storing mode is a mode for fully winding up the seat belt 3 such that the seat belt 3 goes into the storage state when the tongue (such as the tongue 12 in FIG. 1) is released from the buckle for the cancellation of the wearing of the seat belt 3 (i.e., unbuckling) so that the buckle switch (such as the buckle switch 14a in FIG. 1) goes to the OFF state. Hereinafter, the control detail of the belt winding and storing mode method will be described in detail with reference to FIG. 3 through FIG. 7. The control in the first retractor 1 is conducted by the ECU 30 shown in FIG. 1. The flow chart for the belt winding and storing control method in the seat belt apparatus 100 of this embodiment is shown in FIG. 3 and a graph of the changes with time of the seat belt winding-up force in the belt winding and storing control method is shown in FIG. 4. The seat belt apparatus 100 in a first control mode state for the seat belt 3 is shown in FIG. 5; the seat belt apparatus 100 in a second control mode state for the seat belt 3 is shown in FIG. 6; and the seat belt apparatus 100 in a state in which the belt winding and storing control method for the seat belt 3 is terminated is shown in FIG. 7.

In the belt winding and storing control shown in FIG. 3, in step S10, it is determined whether or not the buckle is released (i.e., whether or not the seat belt is switched from the buckled state to the unbuckled state). Specifically, it is determined that the buckle is released when the buckle switch 14a goes from the ON state to the OFF state based on the detected information by the buckle switch 14a which detects the insertion and latching of the tongue 12 relative to the seat belt buckle 14 shown in FIG. 1. This determination is made by the ECU 30 which detects the detected information from the buckle switch 14a. In step S10, this process is continued until the buckle is released and then proceeds to step S20. In step S20 in FIG. 3, a count by a timer (not shown) is started. Then, the process proceeds to step S30.

In step S30 in FIG. 3, a first control mode is set in which the motor 7 of the first retractor 1 is controlled to not be driven. Specifically, the ECU 30 performs a control of outputting a stopping signal to the motor 7 and setting the power transmission mechanism 8 to the power transmission disconnection mode. When this control has been performed at step 10, the control is continued. That is, at step S30, no seat belt winding-up force by the motor 7 acts on the seat belt 3. As mentioned above, in this embodiment, the winding-up force applied to the seat belt 3 by the second return spring 26 of the second retractor 21 is set to be larger than the winding-up force of the first return spring 6 of the first retractor 1.

In the first control mode of the step S30, the seat belt winding-up force Tb acting on the lap belt portion 3b as a part of the seat belt 3 by the second return spring 26 is larger than the seat belt winding-up force Ta acting on the shoulder belt portion 3a as another part of the seat belt 3 by the first return spring 6. (See the First Control Mode in FIG. 4.)

As shown in FIG. 5, the second spool 25 is rotated in the winding direction more rapidly and more strongly than the first spool 5 so that the lap belt portion 3b as a part of the seat belt 3 is mainly (i.e., preferentially) wound up as compared to the other part of the seat belt 3. When the lap belt portion 3b is mainly wound up, a state exists in which the wound amount of the lap belt portion 3b is relatively larger than that of the shoulder belt portion 3a. In the first control mode, the shoulder belt portion 3a may be partially wound up or may not be wound up at all. This operational state may correspond to a situation in which the lap belt portion is wound up onto the second spool of the second winding-up means by controlling the electric motor of the first winding-up means to not be driven.

According to the first control mode as mentioned above, just after the buckle release, the tongue 12 moves substantially horizontally from the region around the occupant's cabin-side hip (on the left side in FIG. 5) corresponding to the position of the buckle 14 to the region around the occupant's door-side hip on the right side in FIG. 5 so that the tongue 12 moves to a position so as not to disturb the vehicle occupant when getting out of the vehicle. The moving path of the tongue 12 is a path across the abdomen or the hip of the vehicle occupant which is shorter than the path of the tongue in the case of moving to an upper part of the vehicle, thereby shortening the time the tongue 12 takes to move to a position so as not to disturb the vehicle occupant when getting out of the vehicle. The moving path lies below the normal eye level of the vehicle occupant and far away from the range of view of the vehicle occupant, thereby preventing the vehicle occupant from feeling uncomfortable due to the movement of the tongue 12. Since the tongue 12 moves substantially horizontally during the winding up of the lap belt portion 3b, the driving force of the second return spring 26 can be reduced as compared to the case of the winding-up so as to lift the tongue 12, thereby enabling a reduction in size, weight, and cost of the second return spring 26. By this arrangement of mainly storing the lap belt portion 3b, the lap belt portion 3b including the tongue 12 is prevented from disturbing the vehicle occupant when getting out of the vehicle and is also prevented from being caught by the door. Therefore, it is no longer necessary to rapidly wind up the shoulder belt portion 3a in the second control mode. The winding speed by the motor 7 can be reduced, thereby preventing discordant motor operating sound and noise generation.

Then, in step S40 in FIG. 3, it is determined whether or not the elapsed time of which counting was started at step S20 reaches a predetermined reference time “ta.” The reference time “ta” is suitably set according to the specification of the seat belt apparatus such as the length of the seat belt 3. In step S40, the process is continued until the elapsed time reaches the reference time “ta” and then proceeds to step S50.

In step S50 in FIG. 3, a second control mode is set in which the motor 7 of the first retractor 1 is controlled to be driven. Specifically, the ECU 30 performs a control of outputting a driving signal to the motor 7 and setting the power transmission mechanism 8 to the power transmission operation mode. Therefore, in step S50, the seat belt winding-up force by the motor 7 acts on the seat belt 3. As mentioned above, in this embodiment, the winding-up force applied to the seat belt 3 by the second return spring 26 of the second retractor 21 is set to be smaller than the total winding-up force of the first return spring 6 and of the motor 7.

Accordingly, in the second control mode in step S50, the seat belt winding-up force Tc acting on the shoulder belt portion 3a as a part of the seat belt 3 by the first return spring 6 and the motor 7 becomes larger than the seat belt winding-up force Tb acting on the lap belt portion 3b as another part of the seat belt 3 by the second return spring 26. (See the Second Control Mode in FIG. 4.) That is, the difference between the seat belt winding-up force Tc and the seat belt winding-up force Ta shown in FIG. 4 is an addition (or an increase) of the seat belt winding-up force by the motor 7.

As shown in FIG. 6, the first spool 5 is rotated in the winding direction more rapidly and more strongly than the second spool 25 so that the shoulder belt portion 3a as a part of the seat belt 3 is mainly (i.e., preferentially) wound up as compared to the other part of the seat belt 3. When the shoulder belt portion 3a is mainly wound up, a state exists in which the wound amount of the shoulder belt portion 3a is relatively larger than that of the lap belt portion 3b. In the second control mode, the lap belt portion 3b may be partially wound up or may not be wound up at all. This operational state corresponds to an arrangement in which the shoulder belt portion is wound up onto the first spool of the first winding-up means by controlling the electric motor of the first winding-up means to be driven.

According to the second control mode as mentioned above, the tongue 12 moves upward from the position so as not to disturb the vehicle occupant when getting out of the vehicle (i.e., the position shown by solid lines in FIG. 6) to an upper side in FIG. 6 just after the first control mode.

Finally, in step S60 in FIG. 3, it is determined whether or not a winding termination condition for winding of the seat belt 3 is satisfied. When it is determined that the winding termination condition is satisfied (the YES path in step S60), the belt winding and storing control method is terminated. The determination may be made in accordance with a predetermined period of time or a condition where the tension on the seat belt 3 reaches a reference value. Therefore, at the end of the belt winding and storing control method, the seat belt 3 is fully wound onto the first spool 5 and the second spool 25 as shown in FIG. 7 so that the seat belt 3 goes into a state in which a very weak belt tension acts on the seat belt 3.

According to the seat belt apparatus 100 of this embodiment as mentioned above, in the first control mode just after the buckle release, the time in which the tongue 12 located in the region around that occupant's door-side hip takes to move to the position so as not to disturb the vehicle occupant when getting out of the vehicle can be reduced. Further, because the moving path of the tongue 12 is far away from the range of view of the vehicle occupant, it can prevent the vehicle occupant from feeling uncomfortable due to the movement of the tongue 12. Because the tongue 12 moves substantially horizontally, the driving force of the second return spring 26 can be reduced, thereby enabling a reduction in size, weight, and cost of the second return spring 26. By this arrangement of mainly storing the lap belt portion 3b, the lap belt portion 3b including the tongue 12 is prevented from disturbing the vehicle occupant when getting out of the vehicle and is also prevented from being caught by the door. Therefore, it is no longer necessary to rapidly wind up the shoulder belt portion 3a in the second control mode just after the first control mode. The winding speed by the motor 7 can be reduced, thereby preventing discordant motor operating sound and noise generation.

According to the seat belt apparatus 100 of this embodiment, because the seat belt winding-up force of the first return spring 6 related to the winding of the shoulder belt portion 3a is set to be smaller than the seat belt winding-up force of the second return spring 26 related to the winding of the lap belt portion 3b, the workload of pulling the seat belt 3 from the first retractor 1 (i.e., the first spool 5) is light, thus facilitating the operation for wearing the seat belt. In addition, the uncomfortable feeling of the vehicle occupant due to the load applied via the shoulder belt portion 3a when wearing the seat belt 3 can be reduced.

In the seat belt apparatus 100 of this embodiment, the warning mode can be performed by controlling the motor 7 related to the winding of the shoulder belt 3a. The shoulder belt portion 3a may be the best portion for warning the driver among the portions of the seat belt 3. Therefore, the seat belt apparatus 100 in which the shoulder belt portion 3a is wound up by the motor 7 is effective for reliably warning the driver through the seat belt 3.

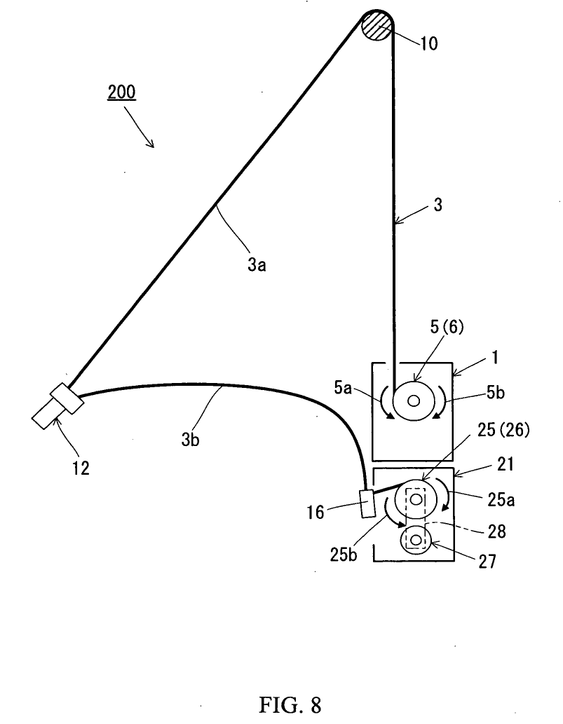

Though the motor 7 is installed in the first retractor 1 in the seat belt apparatus 100 of the aforementioned first embodiment, the motor 7 and the power transmission mechanism 8 of the first retractor 1 may be omitted and an electric motor 27 (like the motor 7) and a power transmission mechanism 28 may be installed in the second retractor 21 according to a second embodiment. The schematic structure of the first retractor 1 and the second retractor 21 in a seat belt apparatus 200 according to the second embodiment is shown in FIG. 8. In the seat belt apparatus 200, the winding-up force applied to the seat belt 3 by the first return spring 6 of the first retractor 1 is set to be larger than the winding-up force of the second return spring 26 of the second retractor 21 and is set to be smaller than the total winding-up force of the second return spring 26 and of the motor 27 when driven.

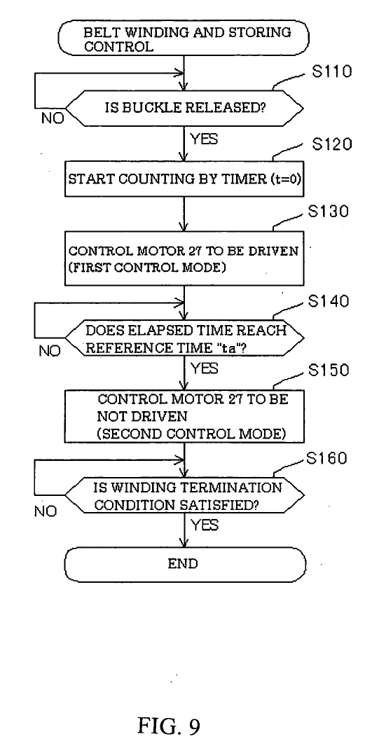

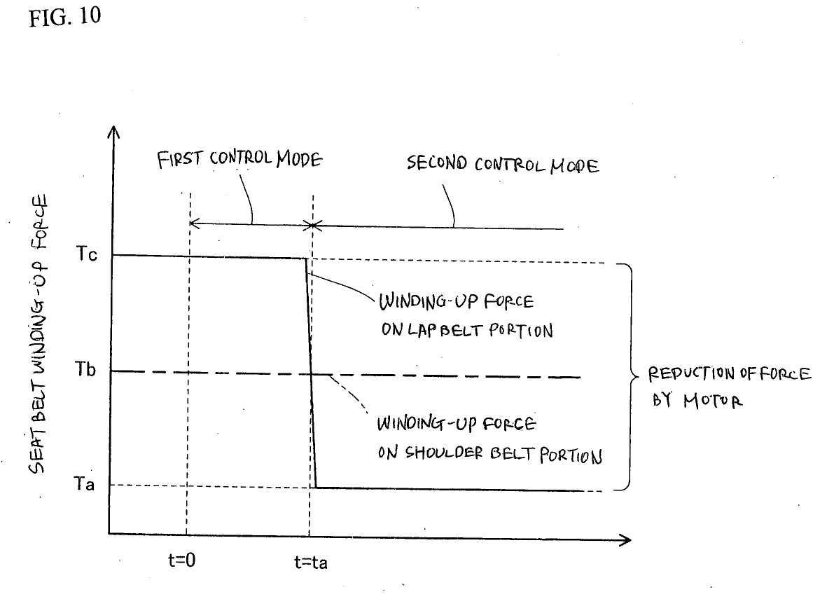

The flow chart for the belt winding and storing control method for the seat belt apparatus 200 of this embodiment is shown in FIG. 9 and a graph of the changes with time in seat belt winding-up force in the belt winding and storing control method is shown in FIG. 10. In the belt winding and storing control shown in FIG. 9, the steps are substantially the same as those of the belt winding and storing control method shown in FIG. 3 except step S130 and step S150. Steps S10, S20, S40, and S60 in FIG. 3 correspond to steps S110, S120, S140, and S160 in FIG. 9, respectively. Therefore, the following description will refer only to step S130 and step S150.

In step S130 in FIG. 9, a first control mode is set in which the motor 27 of the second retractor 21 is controlled to be driven. Specifically, the ECU 30 performs a control of outputting a driving signal to the motor 27 and setting the power transmission mechanism 28 to the power transmission operation mode. Therefore, in step S130, the seat belt winding-up force by the motor 27 acts on the seat belt 3. As mentioned above, in this embodiment, the winding-up force applied to the seat belt 3 by the first return spring 6 of the first retractor 1 is set to be smaller than the total winding-up force of the second return spring 26 and of the motor 27.

Accordingly, in the first control mode at step S130, the seat belt winding-up force Tc acting on the lap belt portion 3b as a part of the seat belt 3 by the second return spring 26 and the motor 27 becomes larger than the seat belt winding-up force Tb acting on the shoulder belt portion 3a as another part of the seat belt by the first return spring 6. (See the First Control Mode in FIG. 10.) Therefore, the second spool 25 is rotated in the winding direction more rapidly and more strongly than the first spool 5 so that the lap belt portion 3b as a part of the seat belt 3 is mainly (i.e., preferentially) wound up as compared to the other part of the seat belt 3. This operational state corresponds to an arrangement in which the lap belt portion is wound up onto the second spool of the second winding-up means by controlling the electric motor of the second winding-up means to be driven.

On the other hand, in step S150 in FIG. 9, a second control mode is set in which the motor 27 of the second retractor 21 is controlled to not be driven. Specifically, the ECU 30 performs a control of outputting a stopping signal to the motor 27 and setting the power transmission mechanism 28 to the power transmission disconnection mode. That is, at step S150, no seat belt winding-up force by the motor 27 acts on the seat belt 3. As mentioned above, in this embodiment, the winding-up force applied to the seat belt 3 by the first return spring 6 of the first retractor 1 is set to be larger than the winding-up force of the second return spring 26 of the second retractor 21.

In the second control mode in the step S150, the seat belt winding-up force Tb acting on the shoulder belt portion 3a as a part of the seat belt 3 by the first return spring 6 is larger than the seat belt winding-up force Ta acting on the lap belt portion 3a as another part of the seat belt by the second return spring 26. (See the Second Control Mode in FIG. 10.) That is, the difference between the seat belt winding-up force Tc and the seat belt winding-up force Ta shown in FIG. 10 is a reduction of the seat belt winding-up force by the motor 27. Accordingly, the first spool 5 is rotated in the winding direction strongly at a high speed as compared to the second spool 25, whereby the shoulder belt portion 3a as a part of the seat belt 3 is mainly (i.e., preferentially) wound up as compared to the other part of the seat belt 3. This operational state corresponds to an arrangement in which the shoulder belt portion is wound up onto the first spool of the first winding-up means by controlling the electric motor of the second winding-up means to not be driven.

The arrangement of the seat belt apparatus 200 according to the second embodiment also exhibits works and effects similar to the works and effects described with regard to the seat belt apparatus 100 of the aforementioned first embodiment. In addition, the motor 27 is used as a power source for the second spool 25 of the second retractor 21 and the motor 27 is driven only within a relatively short period of time just after the buckle release, thereby reducing the time of discordant motor operating sound and noise generation due to the motor 27.

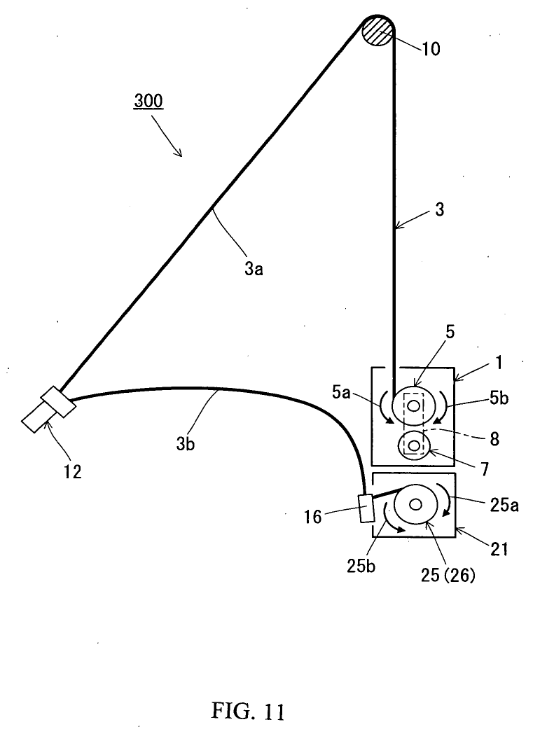

The present invention may also employ an arrangement in which the first return spring 6 of the first retractor 1 is omitted in the seat belt apparatus 100 of the aforementioned first embodiment. The schematic structure of the first retractor 1 and the second retractor 21 in a seat belt apparatus 300 according to the third embodiment is shown in FIG. 11. In the seat belt apparatus 300 shown in FIG. 11, the winding-up force applied to the seat belt 3 by the second return spring 26 is set to be larger than the winding-up force by the motor 7 when it is not driven and smaller than the winding-up force by the motor 7 when it is driven.

The belt winding and storing control method in the seat belt apparatus 300 is achieved by performing sequentially the same steps as the steps in the flow chart shown in FIG. 3. In this case, the operational state in step S30 in FIG. 3 may correspond to an arrangement in which the lap belt portion is wound up onto the second spool of the second winding-up means by controlling the electric motor of the first winding-up means to not be driven and the operational state in step S50 in FIG. 3 may correspond to an arrangement in which the shoulder belt portion is wound up onto the first spool of the first winding-up means by controlling the electric motor of the first winding-up means to be driven.

The arrangement of the seat belt apparatus 300 according to the third embodiment also exhibit works and effects similar to the works and effects described with regard to the seat belt apparatus 100 of the aforementioned first embodiment. In addition, the first return spring 6 of the first retractor 1 is omitted, thereby achieving the simplification, the miniaturization, the reduction in weight, and the reduction in cost of the first retractor 1.

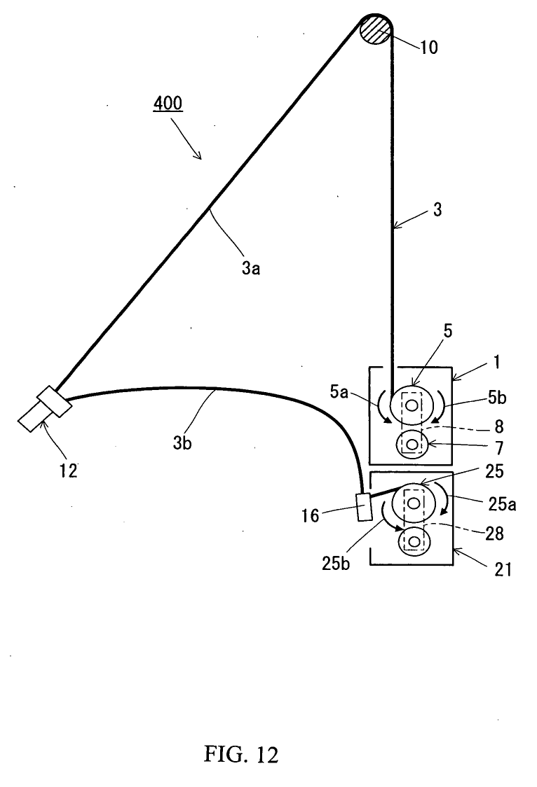

The present invention may also employ an arrangement in which the first return spring 6 of the first retractor 1 and the second return spring 26 of the second retractor 21 are omitted in the seat belt apparatus 100 of the aforementioned first embodiment and an electric motor 27 (like the motor 7) and a power transmission mechanism 28 are installed in the second retractor 21. The schematic structure of the first retractor 1 and the second retractor 21 in a seat belt apparatus 400 according to the fourth embodiment is shown in FIG. 12. In the seat belt apparatus 400 shown in FIG. 12, the first control mode and the second control mode are achieved by controlling the motors of the respective retractors without using the return springs. Specifically, in the first control mode, only the motor 27 of the second retractor 21 is driven to rotate so that the lap belt portion 3b is mainly (i.e., preferentially) wound up. On the other hand, in the second control mode, only the motor 7 of the first retractor 1 is driven to rotate so that the shoulder belt portion 3a is mainly (i.e., preferentially) wound up. The arrangement of the seat belt apparatus 400 according to the fourth embodiment also exhibit works and effects similar to the works and effects described with regard to the seat belt apparatus 100 of the aforementioned first embodiment.

The present invention is not limited to the aforementioned embodiments, thus various variations and modifications may be made. For example, the following embodiments as variations of the aforementioned embodiments may be carried out.

Though the aforementioned embodiments have been described with regard to the cases in which the return springs 6 and 26 and the motor 7 are used as the power source for winding up the seat belt 3, the present invention may employ an arrangement in which a pyrotechnic power source may be used instead of, or in addition to, the return springs and the motor.

The above embodiments have been described with regard to the seat belt apparatuses 100, 200, 300, and 400 to be installed in an automobile; however, the seat belt apparatus of the present invention can be adapted to seat belt apparatuses to be installed in a vehicle for the transfer of occupant(s) such as an automobile, an aircraft, a boat, a train, and a bus.

The priority application Japanese Patent Application No. 2005-247643, filed Aug. 29, 2005 is incorporated by reference.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seat belt apparatus comprising:
a seat belt having a first end side and second end side;
a first winding-up mechanism for winding up the seat belt from the first end side of the seat belt;
a second winding-up mechanism for winding up the seat belt from the second end side of the seat belt;
a tongue; and
a buckle for engaging the tongue,
wherein the first winding-up mechanism and the second winding-up mechanism are configured to operate such that, after a buckle release, a first portion of the seat belt is first wound up and a second portion of the seat belt is then wound up.

2. The seat belt apparatus as claimed in claim 1, further comprising a deflection fitting, wherein the seat belt extends from the first winding-up mechanism through the deflection fitting and further extends to the second winding-up mechanism through the tongue.

3. The seat belt apparatus as claimed in claim 1, wherein the seat belt extends from the first winding-up mechanism through the tongue to the second winding-up mechanism.

4. The seat belt apparatus as claimed in claim 3, wherein the seat belt comprises a shoulder belt portion located between the first winding-up mechanism and the tongue and a lap belt portion located between the tongue and the second winding-up mechanism when the tongue is latched to the buckle.

5. The seat belt apparatus as claimed in claim 4, wherein the first portion of the seat belt is first wound up is the lap belt portion and the second portion of the seat belt then wound up is the shoulder belt portion.

6. The seat belt apparatus as claimed in claim 1, wherein the first winding-up mechanism is configured to apply a first winding-up force to a first spool for winding up the seat belt, and
wherein the second winding-up mechanism comprises a return spring for applying a second winding-up force to a second spool for winding up said seat belt.

7. The seat belt apparatus as claimed in claim 6, wherein the first winding-up mechanism comprises another return spring for applying the first winding-up force to the first spool for winding up the seat belt.

8. The seat belt apparatus as claimed in claim 7, wherein the first winding-up mechanism further comprises an electric motor for applying a third winding-up force to the first spool for winding up the seat belt when the motor is driven,
wherein the second winding-up force applied to the seat belt is set to be larger than the first winding-up force and to be smaller than a sum of the first and third winding-up forces.

9. The seat belt apparatus as claimed in claim 8, further comprising a controller configured to wind up the first portion onto the second spool of the second winding-up mechanism by controlling the electric motor of the first winding-up mechanism to not be driven and to wind up the second belt portion onto the first spool of the first winding-up mechanism by controlling the electric motor of the first winding-up mechanism to be driven.

10. The seat belt apparatus as claimed in claim 6, wherein the second winding-up mechanism further comprises an electric motor for applying a third winding-up force to the second spool for winding up the seat belt when the motor is driven,
the first winding-up force applied to the seat belt is set to be larger than the second winding-up force and to be smaller than a sum of the second and third winding-up forces.

11. The seat belt apparatus as claimed in claim 10, further comprising a controller configured to wind up the first belt portion onto said second spool of said second winding-up mechanism by controlling the electric motor of the second winding-up mechanism to be driven and to wind up said second belt portion onto the first spool of said first winding-up mechanism by controlling the electric motor of the second winding-up mechanism to not be driven.

12. The seat belt apparatus as claimed in claim 6, wherein the first winding-up mechanism comprises an electric motor for applying the first winding-up force to the first spool for winding up said seat belt.

13. The seat belt apparatus as claimed in claim 12, wherein the second winding-up force applied to the seat belt is set to be smaller than the first winding-up force by said electric motor when driven.

14. The seat belt apparatus as claimed in claim 12, further comprising a controller configured to wind up the first belt portion onto the second spool of the second winding-up mechanism by controlling the electric motor of the first winding-up mechanism to not be driven and to wind up the second belt portion onto the first spool of the first winding-up mechanism by controlling the electric motor of the first winding-up mechanism to be driven.

15. The seat belt apparatus as claimed in claim 1, wherein the first winding-up mechanism comprises an electric motor for applying a winding-up force to the first spool for winding up said seat belt, and
wherein the second winding-up mechanism is configured to apply another winding-up force to a second spool for winding up said seat belt.

16. A vehicle comprising:
a running system including an engine;
an electrical system;
a drive control device for performing the drive control of the running system and the electrical system; and
a seat belt apparatus for restraining a vehicle occupant in the event of a vehicle collision, wherein the seat belt apparatus comprises:
a seat belt having a first end side and second end side;
a first winding-up mechanism for winding up the seat belt from the first end side of the seat belt;
a second winding-up mechanism for winding up the seat belt from the second end side of the seat belt;
a tongue; and
a buckle for engaging the tongue,
wherein the first winding-up mechanism and the second winding-up mechanism are configured to operate such that, after a buckle release, a first portion of the seat belt is first wound up and a second portion of the seat belt is then wound up.
